(19) United States
(12) Patent Application Publication
(10) Pub. No.: US 2003/0176951 A1
(43) Pub. Date: Sep. 18, 2003

(54) System integrating a reformer and a fuel cell system

(76) Inventors: Julian A. DeMarchi, Jamaica Plains, MA (US); Brian D. Morriseau, Woburn, MA (US); Jonathan R. Leehey, Wayland, MA (US)

Correspondence Address: MICHAEL D. LAKE, 311 S. WACKER DRIVE, 53RD FLOOR, CHICAGO, IL, 60606-6622, US

(21) Appl. No.: 10/338,600

(22) Filed: Jan. 8, 2003

Related U.S. Application Data
(60) Provisional application No. 60/347,164, filed on Jan. 9, 2002.

(51) Int. Cl. G05D 17/00; G05D 11/00; G05D 9/00; G05D 5/00; G05D 3/12

(52) U.S. Cl. 700/286

(57) ABSTRACT

A system is disclosed having a central processing unit and a control area network with distributive control I/O monitoring and controlling modules for a fuel cell stack and hydrocarbon reformer power system.

### TECHNICAL FIELD

The present invention generally relates to integrated hydrocarbon reformer reactor and fuel cell systems and more particularly to methods and apparatus for control of such systems.

### BACKGROUND OF THE INVENTION

There has been an increasing demand in numerous markets, such as stationary power plants, transportation (vehicles), and other portable power markets, to convert hydrocarbons into a hydrogen-enriched product gas to supply fuel stacks for electric power generation. Hence there have been numerous significant efforts in the art to integrate a fuel reformer, or fuel processor, with a hydrogen fuel cell stack. The burgeoning desire for fuel cells integrated into drive controls for the automobile industry has highlighted the lack of available systems.

The complexity of and potential frailties of either a fuel cell stack or a fuel processor and their respective components alone, creates a need for the real time monitoring and controlling of a wide spectrum of parameters. This is need is compounded when the stack and fuel processor are operably coupled into an integrated system.. Further magnification of control issues related to the integrated system arises when the systems are to be used applications requiring fast turn up and turn downs and dynamic response to varying loads, such as may be desirable in an automotive application. Reliable and sometimes intricate control of the operating parameters of a fuel cell system are believed to be critical for optimized performance and longevity. Fuel cell power systems require accurate and timely control over system inputs and outputs.

Conventional control devices comprise dedicated stand-alone devices. Problems exist with these devices. These dedicated devices monitor a particular attribute of the system, providing feedback and possibly control over that system attribute. Stand-alone monitor and control devices require processor intelligence proximately located near the controlled device. Dedicated, self contained devices tend to require custom designed systems and complex wiring schemes. Such systems are not only costly, but lack efficiency.

As such, stand-alone and custom designed fuel cell power and monitoring devices induce problems with complex wiring and overall inefficiencies.

### SUMMARY OF THE INVENTION

An apparatus has been developed that is suitable for monitoring and controlling a fuel cell stack and such a stack integrated with a fuel processor. The invention has device monitoring I/O modules with embedded controls, each I/O module having one or more specific functions. The I/O modules are connected between the components of the fuel cell system (e.g. a fuel cell stack or hydrogen generative reactor) and a control area network. The I/O modules are responsive to local fuel cell power system parametric data output and communicate relevant system level data through the control area network. The I/O modules act together to implement a system-wide distributed control network coordinated by a central processing unit (CPU). The CPU is a system level controller that preferably governs the system by communication through the control area network. Preferred systems include a system level controller and possibly several I/O modules designed to handle specific I/O such as temperature measurement, cell voltage, and proportional solenoid valve control. The network may be tied into an existing bus-type or distributed networks (such as CAN) or operate as its own entity.

### BRIEF DESCRIPTION OF THE DRAWINGS

FIG. 1 is a simplified schematic of an embodiment of a fuel cell power system distributive control network in accordance with the present invention;

FIG. 2 is side view of a bus having a fuel cell power system distributive control network;

FIG. 3 is a perspective view of a car having a fuel cell power system distributive control network;

FIG. 4 is a simplified schematic of a fuel cell stack and an engine control unit or system level controller operably connected to a CAN-bus network for system monitoring and controlling;

FIG. 5 is the same as FIG. 4 with the addition of a user control panel operably connected to the engine control unit or system level controller;

FIG. 6 is the same as FIG. 5 with the addition of a reformer operably connected to the fuel cell stack; and,

FIG. 7 is the same as FIG. 6 with the addition of I/O monitor(s) operably connected to the CAN-bus network.

### DETAILED DESCRIPTION

While this invention is susceptible of embodiments in many different forms, there is shown in the drawings and will herein be described in detail a preferred embodiment of the invention. The present disclosure is to be considered as an exemplification of the principles of the invention and is not intended to limit the broad aspect of the invention to the embodiments illustrated.

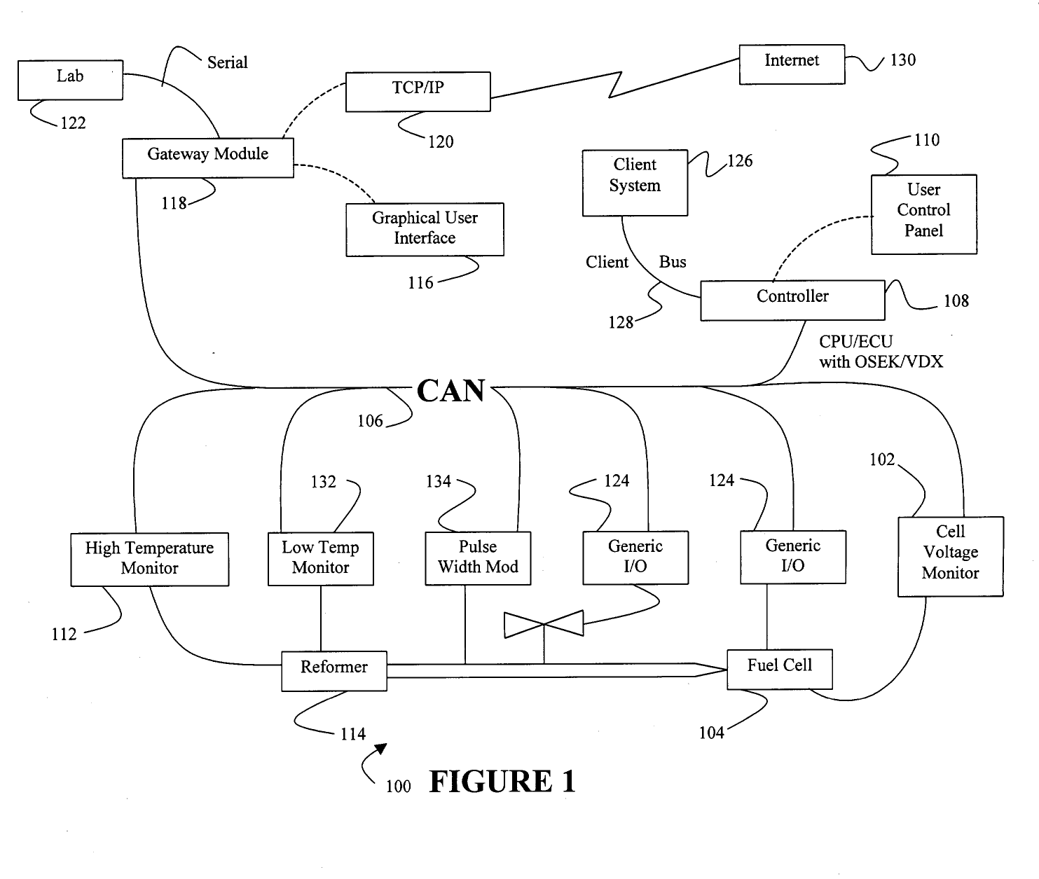

In FIG. 1, a fuel cell power system 100 according to the invention implementing a distributed control network provides a means of paying close attention to system attributes with a view to anticipating approaching danger or opportunity. The fuel cell power system 100 according to the invention includes a control network that has the advantage of placing intelligence at the level of an I/O module. A monitoring I/O module preferably has embedded controls. These I/O modules are configurable to function on a stand-alone basis. The I/O modules, however, are preferably linked with a control area network to a system level controller and other distributed processor I/O monitoring modules. The I/O modules can preferably provide feedback as well as control of the devices they monitor on a standalone or control area network basis. The type of feedback depends on the type of I/O module, which could monitor high temperature 112, low temperature 132, pulse width modulation and relay 134, cell voltage 102, and generic I/O data. The monitored I/O is typically a fuel cell stack and the fuel source, typically a hydrocarbon reformer. As part of a distributive control network, the I/O monitoring module feedback and control capabilities are accessible at the system level controller as well as locally at the I/O module itself. User access to system data is also available through the use of a user control, panel preferably a graphic user interface.

A fuel processor is a device that converts a hydrogen-containing fuel into a gaseous mixture comprising hydrogen, as well as other components such as carbon dioxide. A fuel processor typically conducts multiple reactions, including steam reforming, water gas shift, and clean-up of the hydrogen-containing reformate to meet the requirements of the fuel cell. Each of the separate reactions, and ancillary operations such as steam generation, vaporization of fuel if needed, and elimination of emissions, requires control of temperature, pressure, reaction stoichiometry, and other parameters. The operation of each of the subsystems must be closely coordinated with each other to supply a desired level of hydrogen, and in turn this must be coordinated with the requirements of the fuel cell to produce power. The combination of a fuel cell and a fuel processor, is called a fuel cell power system.

Among the principles of the invention is that the use of distributed control systems within and among the elements of a fuel cell power system has been discovered to be efficient, practical, flexible, and economical in comparison to traditional methods used in fuel processors and fuel cells. This advantage is particularly evident in the control of interconnections within a fuel processor, but extends as well to fuel cells and entire systems. As part of such a control system, an improved method for monitoring the operating condition of a fuel cell stack has been discovered that is both economical and efficient at detecting incipient failure of individual fuel cells of a stack.

Referring now to the drawings, particularly to FIG. 1, a CAN based fuel cell power system distributive control network 100 is disclosed suitable for monitoring and controlling a fuel cell power system. The fuel cell power system distributive control network 100 includes a control area network bus 106 connecting numerous I/O modules. The system level controller 108 governs several controller area network (CAN) 106 connected I/O modules. The I/O modules are preferably co-located in the process side of a fuel cell power system. The system preferably uses actuators and sensors that are locally monitored and network controllable.

Each control area network 106 has a system level controller 108, such as an engine control unit (ECU) 108, typical of those used in automotive applications or the like. Several I/O modules are designed to handle specific system monitor and control I/O functions. I/O modules receive system monitor and control signals from the system level controller 108 through the control area network 106. Preferably, the control system algorithms reside on the system level controller 108. The I/O modules implement embedded processing to essentially perform auxiliary transputing functions to reduce the burden on the system level controller 108.

The system level controller 108 hosts an operating system, preferably an OSEK (Offene Systeme und deren Schnittstellen für die Elektronik im Kraftfahrzeug) compliant real time operating system (RTOS). The RTOS maximizes system safety and reliability, while OSEK specifically is designed for safety and time critical control communications. The system level controller 108 also preferably hosts a CAN-bridge, providing an external CAN interface for fuel cell power system distributive control network integration.

I/O modules preferably coordinate with one another over a digital communications bus 106. CAN-bus capability is integrated within the micro-controller at the heart of each I/O module, as well as the system level controller 108. Each I/O module can be programmed to update the system level controller 108 on a continuous basis, to respond when polled, or to communicate only when an alarm condition exists. These updates are system level relevant data and are preferably transmitted to the system level controller 108 over the control area network 106. System level relevant data is typically generated as a response to system monitor and control signals, preferably initiated by the system level controller 108.

A CAN-specific higher-level protocol (HLP) is used to improve control area network 106 communications. Some CAN/HLP features include the auto-configuration of CAN-bus 106 transmission baud rates prior to system start, validation of each physical CAN-bus 106 link to each I/O module prior to system start, validation of the fuel cell power system distributive control network 100 module configuration prior to system start, software configuration of fuel cell power system distributive control network 100 I/O update intervals between modules, graphical user interface based system configuration 116, real time throughput analysis for CAN communications, and the like. Each I/O module is provided a unique serial number that can be preprogrammed onto a small external chip. The serial identification is used as part of the control area network 106 auto-configuration process. Generally, the fuel cell power system distributed control network 100 of the present invention includes control input/output (I/O) and data acquisition monitoring using “ring” wiring configuration for ease of adding and removing I/O modules.

The fuel cell power system distributive control network 100 can provide a reasonable degree of “fail safe” functionality. Each I/O module can have a relay contact to be used to trip the system emergency stop circuit and/or stop local devices. The relay is optionally tripped when user specified process parameters exceed software configured alarm limits. The relay may also be tripped independently by a watchdog circuit on each I/O module that resets the micro-controller if and when the micro-controller firmware or hardware fails to operate properly.

I/O modules monitor and control their corresponding system devices by local control signals. The local control signals may be a response to system monitor and control signals received at the I/O module. The system monitor and control signal may have been generated locally, at the I/O module or preferably from the controller 108 and transmitted through the bus 106. A large variety of local parametric data may be gathered, recorded, and distributed from the generic I/O module 124 level. Local parametric data is generally filtered and routed through the control area network 106 as system level relevant data to the system level controller 108.

Alarms and warning levels also trigger appropriate control area network 106 level communications with the system level controller 108 and any other I/O modules concerned with automated shutdown. Once enabled and the system is running, the alarm thresholds and logic may only be software configured to be more conservative. Alarm triggering is fully configurable, and not limited to simple I/O level comparisons. Logic can be implemented to trigger warning levels and/or alarms, shut down sequences, etc., based on any combination of input conditions, timing, and other considerations. The fuel cell power system distributive control network 100 remains operable when reconfigurations occur. System reconfiguration can happen because of a loss of power and various other types of connection or communication losses.

In a preferred embodiment, the fuel cell power system distributive control network 100 includes a system level controller or engine control unit 108 that is a central processor. The system level controller 108 coordinates internal process parameters in the fuel cell power system. The system control algorithms for supervisory and most, if not all, direct control of internal processes are implemented by real-time control software running on this system level controller 108.

To allow full stand-alone operation, the control system is preferably embedded within the product. This controller 108 provides a path of departure from system control using lab set-ups running on desktop or laptop PCs, and provides a means for the system to control itself without user intervention. The control area network 100 will have the additional capability to interface with other computers via user connectivity ports. The system level controller or engine control unit module 108 preferably assumes primary control of the system behavior and operation. The system level controller 108 provides project-specific real-time system control.

The system level controller or engine control unit 108 has access to process transducer signals via other CAN modules on the internal CAN-bus 106. The system level controller 108 also allows for direct connection to those other sensors and actuators that are not captured within the functional scope of the other CAN modules in the system. In an embodiment, transducers connected directly to the system level controller or engine control unit module 108 can have some supporting interface circuitry, and work much the same way as with the system level controller or engine control unit's 108 predecessors. Most I/O preferably is transported over the CAN-bus 106 to and from other I/O modules. The I/O modules are dedicated to specific control functions throughout the process side of the fuel processor/fuel cell system.

All control functions necessary to run the system are implemented on the system level controller or engine control unit 108. The controller 108 preferably uses a real-time, multitasking scheduler/operating system (RTOS). The RTOS preferably meets the OSEK/VDX specifications in anticipation of automotive customer requirements. The RTOS implementation also enhances real-time operation, fault-tolerance and recovery, and customer/system safety.

The system level controller or engine control unit 108 preferably handles all alarm conditions reported by other I/O modules and sensors in the system. The system level controller 108 has the capability to implement data logging and connectivity capability if so configured. The reported conditions may then be conferred to the outside world through a gateway module 118.

In an embodiment, the system level controller or engine control unit 108 also acts as a dedicated communications bridge to other networked or CAN-based systems 126. This allows synchronized product-level control using the system as original equipment manufactured component in other products.

A micro-controller with built in CAN ports provides the intelligence for this module 108. Two CAN ports allow it to communicate to other CAN systems. The system level controller 108 has external RAM capability, preferably on the underside, for optional ROM monitor debugging.

Another embodiment of the present invention includes a fuel cell or fuel cell stack 104, a fuel cell reformer 114, and a cell voltage monitoring I/O module 102. The cell voltage monitor 102 measures cell voltages across a range of performances. Preferably, the cell voltage monitor 102 is both CAN-capable and able to operate as a stand-alone unit. Stand-alone operation requires the cell voltage monitor 102 to be self contained and connected to a PC preferably via a standard RS-232 serial connection. The cell voltage monitoring I/O module 102 is designed to mount directly to the fuel cell stack 104 endplate, and can interface to the individual fuel cell stack membrane cells or cell pairs with a custom harness or break out board.

In one embodiment, the cell voltage monitor 102 has a maximum of 64 channels organized in four (4) banks of 16 channels, or 128 cell pairs. Each cell voltage channel has programmable alarm thresholds, and can be set-up to activate the alarm output contact on any combination and/or duration of alarm conditions.

The cell voltage channel can communicate cell voltage, total stack voltage, and/or alarm signals to the system level controller 108 or PC via the chosen control area network, CAN-bus 106, or an RS-232 serial connection. This monitoring system safeguards the fuel cell stack 104 against membrane damage due to excessive stack loading. Preferably, the cell voltage monitor I/O module 102 employs a 30 Hz minimum scan rate across its 64 channels and has 5 mV resolution per channel (0 to 2.5 V, _{±}200V maximum common mode). Additionally, the cell voltage monitor I/O module 102 reports individual cell (pairs) and total stack voltage on demand and tracks and remembers stack load histogram and time in use which includes lifetime fuel cell 104 performance data and post-mortem fuel cell 104 analysis. The unique size and flexibility of the cell voltage monitor 102 allows for custom manufacturing for application to different sized-fuel cell stacks 104.

When the cell voltage monitor 102 is part of the fuel cell power system distributive control network 100, preferably connected to a CAN-bus 106, any data gathered or generated by the cell voltage monitor I/O module 102 is made available to all other I/O modules hooked into the control area network 106. The data may be accessed locally at the I/O module, but preferably at the system level controller 108, or other user interface locations along the CAN-bus 106. The system level controller 108 processes the data transmitted by the cell voltage monitor I/O module 102 and any other control area networked I/O modules.

An embodiment of the fuel cell power system distributive control network 100 can include a generic I/O module 124. The generic I/O module 124 has generic analogue inputs with passive low-pass RC input filtering and digital post filtering logic, as well as generic analog outputs. The generic I/O module 124 also has optoisolated, DC/slow rate, active low, solid state relay digital inputs or outputs and optoisolated, DC/slow rate, active low, solid state relay digital inputs or outputs. Further, the generic I/O module 124 may have pulse width modulator channels active low side switching on all channels, 12-24V DC user supplied transducer power required for all channels, and heat sink/PCB over-temperature protection.

The system level controller 108 is a project specific real time system control with fail-safe system initialization and shut down. The system level controller 108 has user interface/panel 110 interaction (12-24 VDC user supplied DIO power) and partner system CAN-bridging 128 capability. The system level controller 108 further has optoisolated active low digital inputs and outputs each.

In one embodiment, a generic I/O module 124 that provides low-power analog input and output channels, high power digital input and output channels for relay activation, and pulse width modulation channels for motor and valve actuation for fuel cell power system control. The generic I/O module 124 is somewhat different from the other CAN system I/O modules in that it provides no specific control function. It is a generic I/O module 124 in the sense that it can handle any standard, low-voltage input or output required by transducers not captured under the scope of other modules in the control area network 106.

A high degree of application flexibility is attained, by routing power requirements for the transducers through the generic I/O module 124. This allows the system designer to select the most appropriate sensors and actuators available, within the 12-24 VDC actuation range. Cost reduction is also attained by only having to route the power supply to the I/O module, which then distributes it to the individual transducers. Note however that the generic I/O module 124 is typically not equipped to directly handle the current levels usually required by mass flow controllers.

The pulse width modulation and relay and generic I/O module 124 and 134 are somewhat different from the other CAN system I/O modules 102 in that they have special heat dissipation requirements. It is therefore more susceptible to overheating within the process cabinet. But this fact also aids the designer it making power requirements clearer. In an embodiment, this I/O module 134 can only dissipate 50W of energy, and act as a conduit for only about 250W of actuator power. This helps highlight the source of parasitic loads within the system, most of which will be attached to the pulse width modulation and relay I/O module 134.

The generic I/O module 124 is designed to mount easily within the process side of a fuel cell power system. A small I/O module package is obtained using high-density connectors for the inputs and outputs. The generic I/O module 124 has analog input channels, analog output channels, relay level digital input & output channels and solenoid level pulse width modulated output channels. The digital and pulse width modulated outputs are designed to meet the power level needs for solenoid valve actuation. The relay channels can handle sufficient current to continuously power the kinds of solenoids used. The pulse width modulation channels can handle small brushed and torque motors, though high-current motors can be used.

Each channel has programmable alarm thresholds, that can be set up to activate the relay contact on any combination and/or duration of alarm conditions triggered by control software limit violations on outputs, or voltage limit violations on inputs. The I/O module communicates I/O data with the system level controller 108 and/or other interested I/O modules 102 on either a regular or polled basis. Integrity of connections is detected prior to start-up, including a check to ensure the module I/O connectors are not accidentally swapped.

In another embodiment, a high temperature thermocouple I/O module 112 is provided for to measuring type K thermocouple temperatures typically found on the reformer side of the fuel cell power system. The high temperature thermocouple I/O module 112 is designed to be mechanically interchangeable with the low temperature thermistor I/O module 132.

These temperature I/O modules 112 and 132 are relatively simple, but provide some advanced features such as temperature measurement filtering by way of both passive analog components and digital algorithms. Cost reduction is obtained by requiring to route expensive and rigid thermocouple wire from the thermocouples themselves to the I/O module 112,132 only, rather than all the way back to the system level controller 108. Expensive thermocouples and thermocouple wire are replaced with cheaper thermistor technology. Temperature data are transmitted digitally via the CAN-bus 106 to the system level controller 108 instead, increasing signal-to-noise robustness and decreasing implementation costs.

The high temperature thermocouple I/O module 112 is preferably designed to mount easily within the process side of a fuel cell power system. A small I/O module package is obtained using high-density connectors for the inputs. The high temperature I/O module 112 has a plurality of type K thermocouple input channels, specifically designed for temperature measurement. The I/O module 112 is also able to monitor its own temperature.

Each channel has programmable alarm thresholds that can be set up to activate the relay contact on any combination and/or duration of alarm conditions triggered by temperature limit violations. The temperature I/O modules 112 and 132 report temperature data to the system level controller 108 and/or other interested I/O modules on either a regular or polled basis.

Integrity of thermocouple connections is automatically checked prior to start-up. The high temperature I/O module 112 also checks to ensure that a high temperature thermocouple I/O module connector is not accidentally swapped with a low temperature thermistor I/O module connector.

In yet another embodiment, a low temperature thermistor I/O module 132 is provided for measuring the lower temperatures typically found on the fuel cell side of the fuel cell power system. The low temperature thermistor I/O module 132 is specially designed to be mechanically interchangeable with the high temperature thermocouple I/O module 112. In still yet another embodiment, a pulse width modulation and relay module 134 is provided with the key functionality for fuel cell processor system control in the form of valve and motor actuation with intermediate power requirements.

A high degree of application flexibility is preferably attained, by routing power requirements for the actuators through the module itself. This allows the system designer to select the most appropriate valves and brush motors available, within the 12-24 VDC actuation range. Cost reduction is also attained by only having to route the power supply to the module, which then distributes it to the controlled actuators.

The pulse width modulation and relay module 134 is designed to mount easily within the process side of a fuel cell power system. Special connections are provided for the high power delivered through the pulse width modulation channels on the module. A small module package is retained using high-density connectors for the relay outputs.

The pulse width modulation and relay module 134 has a plurality of relay channels and pulse width modulation channels. The relay channels can handle sufficient current to continuously power the kinds of solenoids used. The pulse width modulation channels can handle small brushed and torque motors, though high-current motors can be used at once per module (even though there are four channels total). Alternatively, the functionality of the pulse width modulation and relay module 134 can be incorporated into another module, such as the generic I/O module.

The low temperature thermistor I/O module 132 is designed to mount easily within the process side of a fuel cell power system. A small I/O module package is obtained using high-density connectors for the inputs. The low temperature I/O module 132 has a plurality of thermistor input channels, specifically designed for variable resistance measurement.

Each channel has programmable alarm thresholds that can be set up to activate the relay contact on any combination and/or duration of alarm conditions triggered by temperature limit violations. The temperature I/O modules 112 and 132 report temperature data to the system level controller 108 and/or other interested I/O modules on either a regular or polled basis.

Integrity of thermistor connections is automatically checked prior to start-up. The I/O module also checks to ensure that a low temperature thermistor I/O module connector is not accidentally swapped with a high temperature thermocouple I/O module connector.

Yet a further embodiment provides a gateway I/O module 118 to enable TCP/IP communications 120 and log all internal process parameters and system wide data in fuel cell power systems. The gateway I/O module 118 provides communication with other systems and the “outside world” via TCP/IP 120 and the Internet 130 for feedback, process control, diagnostic and debugging purposes. It can optionally be able to host a separate graphic user interface I/O module 116 for any systems having this requirement.

Since the two functions are tied so closely together, it is preferred that a single gateway I/O module 118 has both data logging and communications capability. Communication is available in a variety of options, including TCP/IP 120 and serial 122 (standard) and CAN-bus 106 connectivity to interface the fuel processor systems with other products. Most other protocols can be added ad-hoc using very small, third-party protocol bridges between, for example, RS-232 and RS-485, or CAN and any other industrial field-bus technology, home appliance networking technology, or even wireless communications technology.

Anticipating the possibility for user-friendly interface requirements that do not compromise real-time system controllability by the system level controller or engine control unit 108 of the system, the gateway module 118 offloads asynchronous communications overhead between the system and the outside world. The gateway module 118 is able to interface with either a separate graphical user interface system 116 or even host a local web server for remote monitoring and embedded software update capabilities.

In another embodiment, the gateway module 118 is the only system module that does not have fault-relay capability. This is a system security feature. The module 118 functions may also include CAN-bus 106 data traffic tracing, providing bus-load statistics, viewing data segments of specified messages, message recording for off line evaluation, and monitoring error frames on the bus line. As a further alternative, the functionality of the module 118 may be incorporated in another module, such as the system controller, CPU/ECU 108.

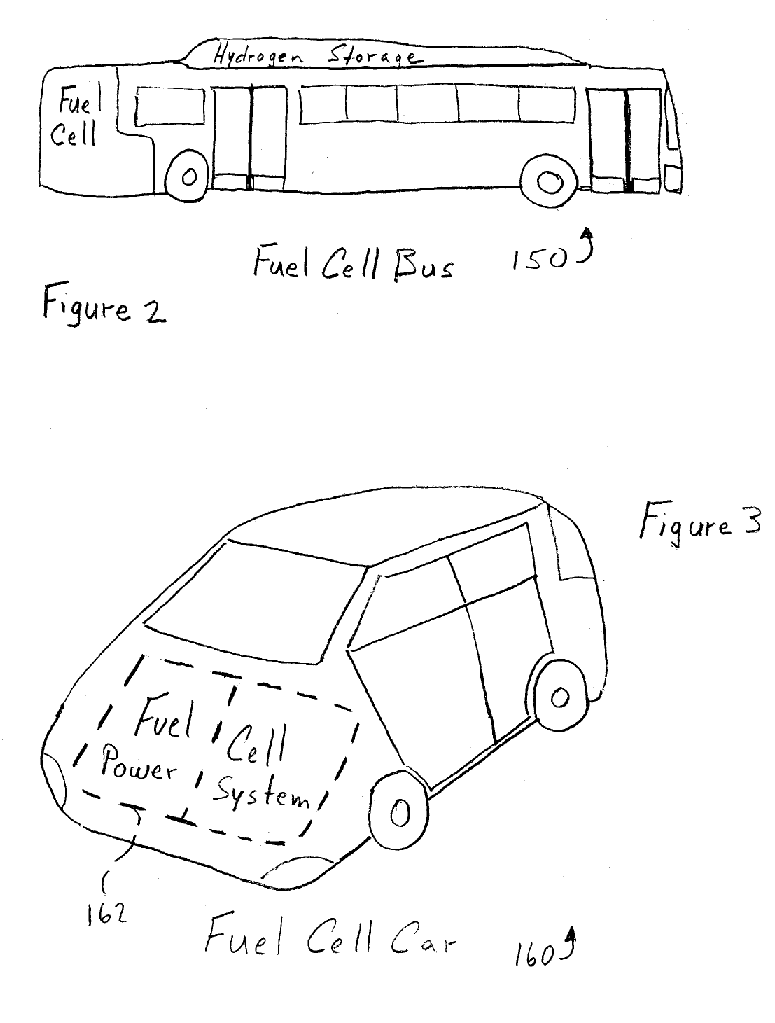

Another application of the fuel cell power system distributed control network 100 is in the transportation industry as depicted in FIGS. 2 and 3. The system may be implemented to power buses 150, cars 160, and other vehicles. The simplified view of a fuel cell power system distributed control network 162 can be used in many of the same ways that engines and other power sources are put into practice.

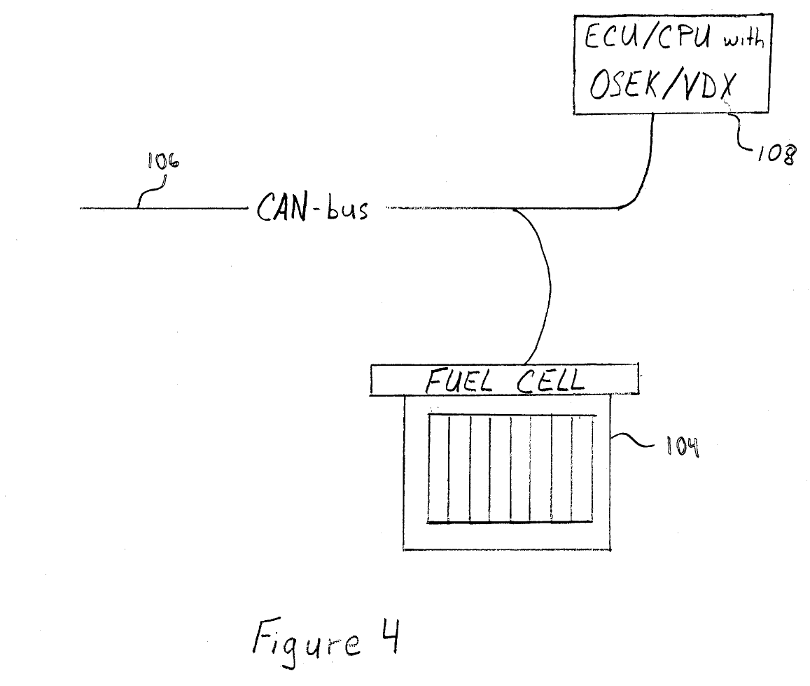

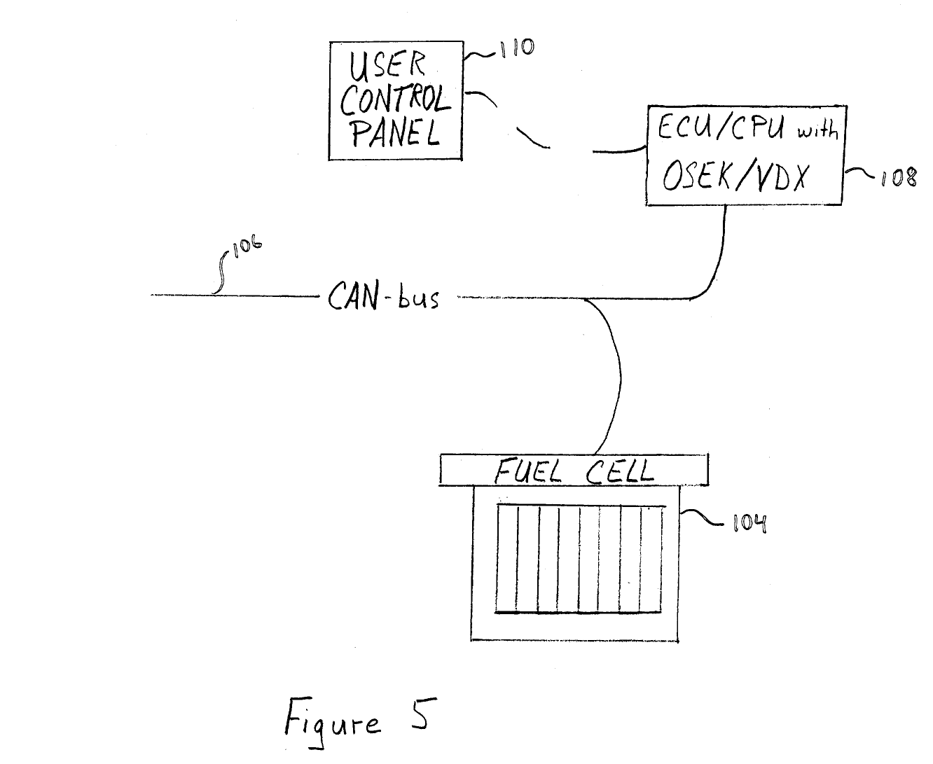

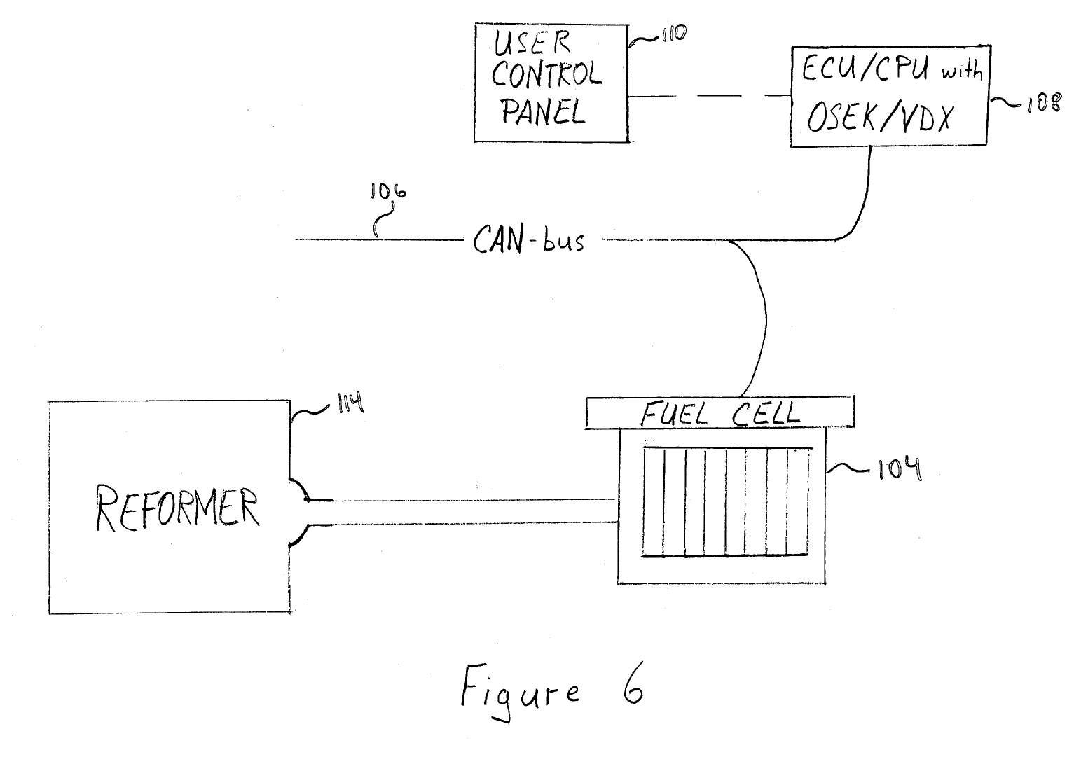

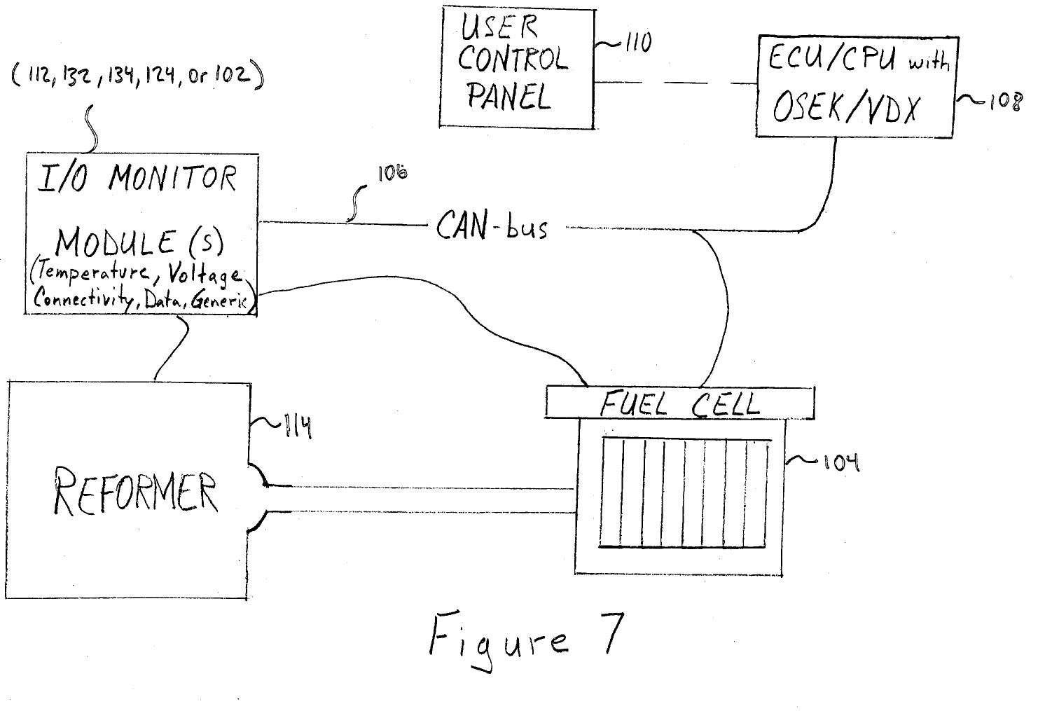

Turning to FIGS. 4-7, alternative embodiments of a fuel cell power system distributive control network are shown. In FIGS. 4-7, reference numbers that are the same as those in FIG. 1 correspond to like elements therein.

1. An apparatus for monitoring and controlling an integrated fuel cell power system comprising:
a first control area network;
a fuel cell stack;
a fuel cell I/O module with embedded controls operably connected between the fuel cell stack and the first control area network, the fuel cell I/O module is responsive to local fuel cell power system parametric data output and the fuel cell I/O module communicates data relevant to system level criteria throughout the first control area network, and
a system level controller operably connected to the first control area network.

2. The apparatus of claim 1, further comprising the fuel cell stack operably connected to a hydrogen source.

3. The apparatus of claim 2, wherein the hydrogen source is a hydrocarbon reformer.

4. The apparatus of claim 3, further comprising the reformer including a burner and the system including a burner I/O module with embedded controls operably connected between the reformer and the first control area network, the burner I/O module is responsive to local fuel cell power system parametric data output and the burner I/O module communicates data relevant to system level criteria throughout the first control area network.

5. The apparatus of claim 4, further comprising a generic I/O module responsive to local fuel cell power system parametric data and the generic I/O module communicates data relevant to system level criteria throughout the first control area network.

6. The apparatus of claim 5, wherein the generic I/O module records fuel cell power system local parametric data input.

7. The apparatus of claim 5, wherein the generic I/O module records fuel cell power system local parametric data output.

8. The apparatus of claim 5, wherein the generic I/O module is responsive to system monitor and control signals to generate local control signals.

9. The apparatus of claim 5, wherein the controller is configured to provide system monitor and control signals to the generic I/O module.

10. The apparatus of claim 1, wherein the controller is responsive to the system level relevant data.

11. The apparatus of claim 1, wherein the system relevant data is recorded by the controller.

12. The apparatus of claim 1, wherein the controller has a graphic user interface.

13. The apparatus of claim 1, wherein the controller is an engine control unit.

14. The apparatus of claim 1, wherein the controller monitors connectivity of the system.

15. The apparatus of claim 1, wherein the first control area network is configured to operate when the modules are reconfigured.

16. The apparatus of claim 5, wherein the generic I/O module also includes an apparatus for permitting control of the generic I/O module separate from the system level control.

17. The apparatus of claim 1, wherein the system relevant data is preserved by the controller when reconfiguration of the first control area network occurs.

18. The apparatus of claim 5, wherein the system relevant data is preserved by the generic I/O module when reconfiguration of the first control area network occurs.

19. The apparatus of claim 1, wherein the first control area network is a ring wiring configuration serial bus system.

20. The apparatus of claim 1, wherein the controller has an operating system and the operating system runs in real time.

21. The apparatus of claim 20, wherein the operating system is OSEC 2.1 compliant.

22. The apparatus of claim 1, further comprising the first control area network operably connected to a second control area network.

23. The apparatus of claim 5, wherein the generic I/O module communicates a local control signal to the fuel cell stack.

24. The apparatus of claims 5, wherein the generic I/O module monitors and controls a fan.

25. The apparatus of claims 5, wherein the generic I/O module monitors and controls a pump.

26. The apparatus of claims 5, wherein the generic I/O module monitors and controls a valve.

27. The apparatus of claim 5, wherein the generic I/O module, operably connected to the control area network, monitors all local parametric data and controls all local signals within the fuel cell power system.

28. The apparatus of claim 5, further comprising a plurality of generic I/O modules, operably connected to the control area network, autonomously monitor local parametric data and control local I/O within the fuel cell power system.

29. The apparatus of claim 5, wherein the generic I/O module monitors and controls local parametric data relating to a low temperature.

30. The apparatus of claim 5, wherein the generic I/O module monitors and controls local parametric data relating to a high temperature.

31. The apparatus of claim 5, wherein the generic I/O module monitors and controls local parametric data relating to a flame sensor.

32. The apparatus of claim 5, wherein the generic I/O module monitors and controls local parametric data relating to an air flow.

33. The apparatus of claim 5, wherein the generic I/O module monitors and controls local parametric data relating to a fuel cell voltage.

34. The apparatus of claim 5, wherein the generic I/O module exclusively monitors and controls local parametric data pertaining to temperature.

35. The apparatus of claim 5, wherein the generic I/O module exclusively monitors and controls local parametric data pertaining to pulse width modulation.

36. The apparatus of claim 1, wherein the system level controller updates software via remote communication.

37. The apparatus of claim 5, wherein the generic I/O module creates a safety circuit emergency stop loop.

38. The apparatus of claim 5, wherein the generic I/O module coordinates DC-AC inverter fuel cell power generation.

39. The apparatus of claim 5, wherein the generic I/O module coordinates system power flow external and internal parasitic load management.

40. The apparatus of claim 28, wherein a first generic I/O module acts as a smart internal bus power supply regulator for other I/O modules.

41. The apparatus of claim 5, wherein the generic I/O module controls a safety circuit.

42. The apparatus of claim 5, wherein the generic I/O module controls an auxiliary boiler.

43. The apparatus of claim 5, wherein the generic I/O module is capable of system level controlling.

44. The apparatus of claim 1, wherein the controller is capable of communicating via a plurality of protocols simultaneously.

45. The apparatus of claim 1, wherein the controller is DeviceNet compliant.

46. The apparatus of claim 22, wherein the controller is configurable as a master or a slave.

47. A fuel cell power system comprising:
a controller such as an ECU or CPU communicatively connected to a control area network, preferably a CAN protocol network, and in communication with a plurality of generic I/O modules having embedded controls for monitoring and controlling a fuel cell stack and its associated hydrogen supply source.

48. The system of claim 47 wherein hydrogen supply is a hydrocarbon reformer and the system having one or more generic I/O modules with embedded controls to monitor and control the operation of the reformer including monitor and control such as temperatures, pressures, hydrocarbon feed rate, mass flow through the reformer, air feed rate, water and steam generation and feed rates, and or total thermal out put.

49. A method of operating a fuel cell system comprising:
measuring parametric information of a fuel cell or a fuel processor integrated with the fuel cell;
communicating information relative to measurement to a bus; and
accessing the bus via one or more module selected from the group consisting of a high temperature monitor, a low temperature monitor, a pulse width modulation and relay module, a cell voltage monitor, a controller, and a generic I/O module.
